(19) United States
(12) Patent Application Publication
(10) Pub. No.: US 2026/0009379 A1
(43) Pub. Date: Jan. 8, 2026

(54) COMPOSITE DIAPHRAGM FOR DIAPHRAGM PUMP

(71) Applicants: Joachim Oehrle, Herrenberg (DE); Adithya Arun Shetty, Neckarsulm (DE); Jiajia Xu, Stuttgart (DE)

(72) Inventors: Joachim Oehrle, Herrenberg (DE); Adithya Arun Shetty, Neckarsulm (DE); Jiajia Xu, Stuttgart (DE)

(21) Appl. No.: 19/258,142

(22) Filed: Jul. 2, 2025

(30) Foreign Application Priority Data
Jul. 4, 2024 (DE) 102024119053.1

(51) Int. Cl. F04B 43/00; F04B 43/02

(52) U.S. Cl. CPC F04B 43/0063; F04B 43/02; F05C 2225/02; F05C 2225/08

(57) ABSTRACT

A composite diaphragm for a diaphragm pump or the like is formed of a flexible membrane with an outer edge, an inner part and a flexible membrane portion connecting the outer edge to the inner part. This flexible membrane is formed at least partially from an ultrahigh-molecular-weight polyethylene and another layer is formed from an elastomer selected from the group consisting of acrylonitrile-butadiene rubber, hydrogenated acrylonitrile-butadiene rubber, ethylene-propylene-diene rubber, chloroprene rubber, styrene-butadiene rubber, fluororubber, silicone rubber and fluorosilicone rubber.

### FIELD OF THE INVENTION

The present invention relates to a composite diaphragm. More particularly this invention concerns such a diaphragm for a diaphragm pump.

### BACKGROUND OF THE INVENTION

Such a diaphragm typically has a flexible membrane with an outer edge, an inner part, and a flexible portion connecting the outer edge to the inner part. In particular, the outer edge forms a clamping surface via which the composite diaphragm can be mounted for example in a diaphragm pump.

Composite diaphragms of the type described above can be used for example to react to differential pressures, in particular of servo elements, actuators, brake boosters or the like. They can also be used in pressure reducers, pressure regulators or flow regulators. In addition, they are also suitable for use in valves, e.g. pressure relief valves, safety valves, shut-off valves or one-way valves.

Preferably, the invention relates to composite diaphragms intended for diaphragm pumps and thus for pump use. Such pumps may be, for example, metering pumps, mechanical pumps, diaphragm compressors or vacuum pumps. The use in diaphragm pumps, e.g. compressed air diaphragm pumps, is particularly suitable.

Composite diaphragms are usually circular and have a plate shape. Against this background, they are also referred to as disk diaphragms. However, the invention is not limited to such embodiments, but also relates to roll diaphragms, corrugated diaphragms, spherical diaphragms and flat diaphragms. The corresponding composite diaphragm can then be clamped at the edge while the inner part of the composite diaphragm performs moves, whereby the flexible membrane section is inverted with each lifting movement, so that rolling movements of the flexible material can be observed in a radial section. Against this background, the flexible membrane section is also referred to as a rolling loop in the prior art.

The inner part usually does not take part in the rolling movement, so that an insert made of an inflexible or dimensionally stable material can also be provided inside the inner part. This insert is then connected to a piston rod so that the rolling movement can be introduced into the composite diaphragm via the insert. According to the state of the art, the membrane is usually at least partially made of polytetrafluoroethylene (PTFE) and forms a cover layer on the media side. This is usually provided as an independent support film, which can then be bonded to an inner part material of the membrane.

Corresponding designs are known, for example, from U.S. Pat. Nos. 7,905,172, 5,217,797, or 11,585,336, all of which are herewith incorporated by reference. Corresponding composite diaphragms with a PTFE support layer on the media side are used in particular when toxic or chemically aggressive media are to be conveyed. The media side of the membrane is usually formed by the PTFE cover layer since PTFE is particularly resistant to almost all known chemicals.

Such a design has generally proven itself in practice, although polytetrafluoroethylene can only be recycled at high energy cost and in small quantities. It should be noted here that disposal, which is usually carried out by thermal decomposition, releases hydrofluoric acid that can damage the recycling equipment itself.

### OBJECTS OF THE INVENTION

It is therefore an object of the present invention to provide an improved composite diaphragm that can still be used in a known manner, particularly with chemically aggressive and toxic media, but which is also characterized by improved recyclability.

### SUMMARY OF THE INVENTION

This object is attained according to the invention in that the flexible membrane has an outer edge, an inner part and a flexible membrane section connecting the outer edge to the inner part. Here the membrane is formed at least partially from an ultrahigh-molecular-weight polyethylene (PE-UHMW).

In this context, an ultrahigh-molecular-weight polyethylene is understood to be a polyethylene having an average molecular weight of at least 5000 g/mol, preferably at least 10,000 g/mol, particularly preferably at least 50,000 g/mol. Typically, the average molecular weight of such polyethylenes is between 5000 and 50 million g/mol, preferably between 10,000 and 10 million g/mol, particularly preferably between 50,000 and 2 million g/mol.

Like polytetrafluoroethylene, ultrahigh-molecular-weight polyethylene is characterized by high chemical resistance. In addition, tests have shown that even when using corresponding composite diaphragms, a high structural resistance of the membrane can still be guaranteed despite a high number of movements. In such an embodiment according to the invention, the use of polytetrafluoroethylene can therefore be dispensed with. In particular, the membrane, preferably the entire composite diaphragm, is formed completely without polytetrafluoroethylene.

According to a preferred further development of the invention, the membrane is formed entirely from the ultrahigh-molecular-weight polyethylene at least on one face. The one face is, in particular, the face of the membrane on the media side or that comes into contact with the medium to be conveyed when used as intended, for example in a diaphragm pump. The complete formation of this face from the ultrahigh-molecular-weight polyethylene ensures that only the ultrahigh-molecular-weight polyethylene contacts the medium, so that the chemical resistance of the composite diaphragm is ensured by the use of the ultrahigh-molecular-weight polyethylene.

According to a preferred embodiment, the membrane is a laminate. In particular, the membrane has a cover layer of the ultrahigh-molecular-weight polyethylene and another layer. Accordingly, not the entire membrane not made of the ultrahigh-molecular-weight polyethylene. Rather, the ultrahigh-molecular-weight polyethylene is preferably provided exclusively as part of the cover layer provided on the other layer of the membrane. Accordingly, the other layer can then also form a second face, which is accordingly arranged on an opposite side of the composite diaphragm facing away from the media side.

The other layer is preferably formed from an elastomer. The elastomer is preferably selected from the group comprising acrylonitrile-butadiene rubber (NBR), hydrogenated acrylonitrile-butadiene rubber (HNBA), ethylene-propylene-diene rubber (EPDM), chloroprene rubber (CR), styrene-butadiene rubber (SBR), fluoro rubber (FKM), silicone rubber (VMQ) and fluorosilicone rubber (FVMQ).

Depending on the elastomers used, the cover layer can be bonded to the other layer in different ways. The preferred design is for the cover layer to bond directly to the other layer. However, such a design requires that a sufficient adhesive effect can be created between the cover layer and the other layer, one that can also withstand the various rolling movements. Such a design is particularly useful if the other layer is made of ethylene propylene diene rubber (EPDM). In this case, the membrane or at least the cover layer can be bonded directly to the other layer. The connection is preferably made using a compression molding process. The material for the other layer is inserted into a molding press, whereby the molding press consists of an upper and a lower press part that together form the finished composite diaphragm. A corresponding composite diaphragm can then be formed from the material for the other layer by applying heat and pressure.

At the same time, it is also possible to join the other layer with the top layer during the compression-molding process. The cover layer is then provided in the form of a separately produced overlay film and placed above the material for the other layer inside the molding press. The pressure and heat cause the materials to vulcanize together, whereby the adhesive effect between the other layer and the top layer has proven to be sufficiently stable, especially in the case of a combination of EPDM and PE-UHMW, so that further measures to strengthen the adhesive effect are not absolutely necessary.

However, only an insufficient adhesion can be ensured between the cover layer and the other layer due to the choice of material and the manufacturing method, an alternative embodiment can also provide for an adhesion-promoting layer to be provided between the cover layer and the other layer. Accordingly, the cover layer can be connected to the other layer by incorporating in it this adhesion-promoting layer. The adhesion-promoting layer consists in particular of a polyurethane adhesive.

A preferred further development of the invention also provides for a cover layer to be on the other layer. With the aid of this cover layer, the strength of the membrane can be increased. In particular, it is envisaged that the cover layer is formed from a fabric, in particular from polyamide, polyester and/or HT polyamide.

In the context of the invention, it is generally sufficient if the cover layer only forms a closed first face. Accordingly, the cover layer can be comparatively thin. In particular, it is envisaged that the cover layer has a thickness of between 0.15 and 1.5 mm, preferably between 0.2 and 1.2 mm.

In such an embodiment, ridges can also form bumps in the layers. Preferably, the bumps are designed as spherical rings with a circular or elliptical inner part. The bumps form punctual stiffeners in the flexible membrane section. The areas between the ridges are flexible, so that the flexible membrane section can be turned over with little pressure, whereby the punctual reinforcements prevent the formation of any accumulation folds or buckling lines in the support layer.

When used, the composite diaphragm performs defined rolling movements, and the rolling resistance of the rolling fold is low. The dimpled structure of the composite diaphragm on the media side also results in better adhesion between the membrane and the support layer made of ultrahigh-molecular-weight polyethylene. The improved adhesion of the composite layer is due to an interlocking effect of the dimples or to a larger face area due to the dimpled formations.

A particularly preferred further development of the invention further provides that the inner part forms a chamber for holding an insert. In this case, the chamber is formed by an upper and a lower wall, with the upper wall forming part of the first face and the insert being between the upper and the lower wall. The insert is preferably a dimensionally stable insert correspondingly formed from a dimensionally stable material.

In particular, it is intended that the insert is made of aluminum, brass, steel, stainless steel or plastic. The insert can also have a seat for a piston rod. In particular, the piston rod is threaded into the seat in the insert, so that the piston rod can be attached to the insert via the corresponding thread. Although the composite diaphragm described above can be used for a variety of applications, the invention provides that a diaphragm pump is also an object of the invention, the diaphragm pump having a composite diaphragm according to the invention.

### BRIEF DESCRIPTION OF THE DRAWING

The above and other objects, features, and advantages will become more readily apparent from the following description, reference being made to the accompanying drawing in which:

FIG. is an isometric view of a composite diaphragm according to the invention;

FIG. 2 is a section through an alternative embodiment of the composite diaphragm like that of FIG. 1; and

FIG. 3 shows a composite diaphragm without an insert integrated in its inner part.

### SPECIFIC DESCRIPTION OF THE INVENTION

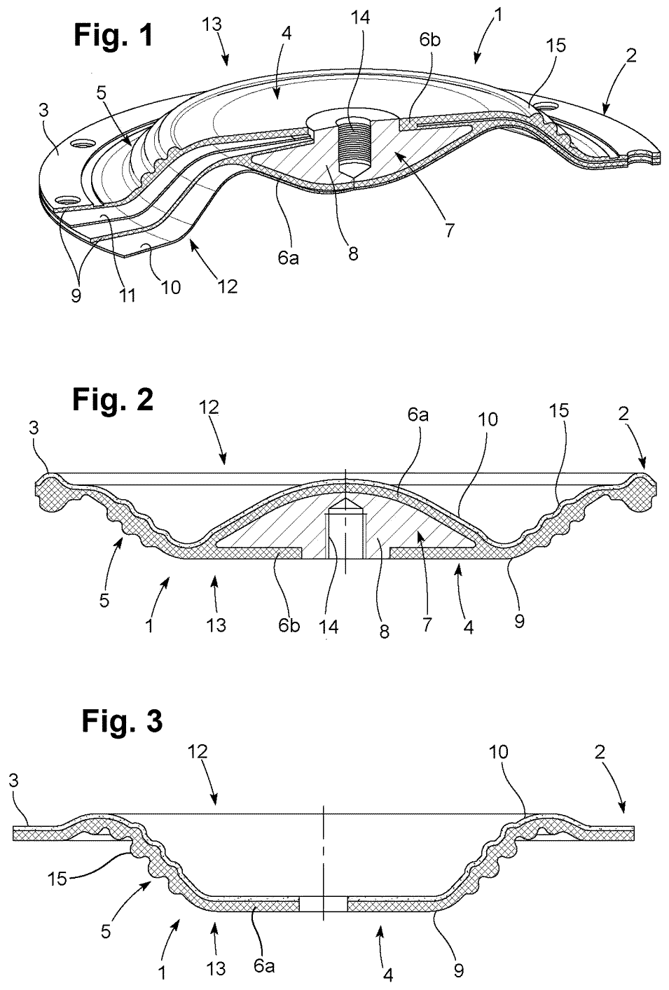

FIG. 1 shows a composite diaphragm 1 according to the invention mainly formed mainly as a flexible membrane having an outer edge 2 provided with a clamping ring 3 and an annular flexible portion 5 connecting the outer edge 2 to an inner part 4. The inner part 4 in FIGS. 1 and 2 is formed by upper and lower walls 6a and 6b that together form a chamber 7 filled by an insert 8 made of a dimensionally stable material.

The membrane 4 is a laminate and essentially consists of a layer 9 formed from an elastomer and a layer 10 on the lower face as shown in FIG. 1 or the upper face as shown in FIGS. 2 and 3. A reinforcing core layer 11 shown only in FIG. 1 is also imbedded in the layer 9 and serves to increase the strength of the membrane 4.

According to the invention, it is now envisaged that the cover layer 10 is formed from an ultrahigh-molecular-weight polyethylene (PE-UHMW). In contrast to previously known solutions, the polytetrafluoroethylene (PTFE) frequently used up to now is thus replaced by the ultrahigh-molecular-weight polyethylene. Like polytetrafluoroethylene, this has a high chemical resistance and is therefore suitable for use with toxic or chemically aggressive media. At the same time, ultrahigh-molecular-weight polyethylene is much easier and more environmentally friendly to recycle.

FIG. 1 shows that the cover layer 10 is provided on a lower face 12 of the layer 9 turned toward the media being pumped. The layer 9 can be coextruded together with the cover layer 10 to be tightly bonded thereto. In addition, however, it is of course also conceivable to provide the cover layer 10 as a separate overlay film, which is then bonded to the layer 9 by incorporating an adhesion-promoting layer not shown in detail. In this case, it is then also possible to use materials for the layer 9 that would otherwise not be able to form a sufficiently strong bond with the top layer 10 without incorporating an adhesion-promoting layer. In the case of EPDM in particular, however, it is intended that the layer 9 is coextruded together with the outer layer 10.

An upper face 13 of the membrane 1 not exposed to the medium being pumped is formed by the layer 9. The face 13 has an opening in the inner part 4 through which the insert 8 extends. In addition, the insert 8 has an internal thread 14, via which a membrane piston, not shown in detail, can be connected to the insert 8.

FIG. 2 shows a further development of the composite diaphragm as shown in FIG. 1, whereby the outer periphery 2 and the clamping ring 3 are formed by a thickened edge. In addition, a large number of ridges 15 are provided in the area of the flexible membrane section 5, which are also shown in FIG. 1, although according to FIG. 2 these ridges 15 form elevations in the cover layer 10. This can further improve the bond strength between the other layer 9 and the cover layer 10.

The composite diaphragm shown in FIG. 3 has a largely identical design to the composite diaphragms shown in FIGS. 1 and 2, although the inner part 4 now only has a wall 6, which does not form a chamber 7, so that accordingly no insert 8 can be provided inside a corresponding chamber 7.

1. In a composite diaphragm for a diaphragm pump, diaphragm being formed of a flexible membrane with an outer edge, an inner part and a flexible membrane portion connecting the outer edge to the inner part, the improvement wherein:
the flexible membrane is formed at least partially from an ultrahigh-molecular-weight polyethylene and another layer is formed from an elastomer selected from the group consisting of acrylonitrile-butadiene rubber, hydrogenated acrylonitrile-butadiene rubber, ethylene-propylene-diene rubber, chloroprene rubber, styrene-butadiene rubber, fluororubber, silicone rubber and fluorosilicone rubber.

2. The composite diaphragm according to claim 1, wherein the membrane has at least one face formed entirely from the ultrahigh-molecular-weight polyethylene.

3. The composite diaphragm according to claim 1 wherein the membrane is a laminate.

4. The composite diaphragm according to claim 3, wherein the membrane has a cover layer of the ultrahigh-molecular-weight polyethylene and the other layer.

5. The composite diaphragm according to claim 4, wherein the cover layer directly abuts the other layer.

6. The composite diaphragm according to claim 4, wherein the cover layer abuts the other via an adhesion-promoting layer.

7. The composite diaphragm according to claim 1, wherein the cover layer is on or embedded in the other layer.

8. The composite diaphragm according to claim 4, wherein the cover layer has a thickness of between 0.15 and 1.5 mm.

9. The composite diaphragm according to claim 8, wherein the thickness is between 0.2 and 1.2 mm.

10. The composite diaphragm according to claim 1, wherein the flexible membrane portion is formed with a plurality of ridges.

11. The composite diaphragm according to claim wherein the inner part forms a chamber adapted to hold an insert.

12. Use of the composite diaphragm according to claim 1 in a diaphragm pump.
